(19) United States
(12) Patent Application Publication
(10) Pub. No.: US 2018/0101218 A1
(43) Pub. Date: Apr. 12, 2018

(54) APPARATUSES AND METHODS FOR ADJUSTING PROCESSING CAPABILITIES

(71) Applicant: MediaTek Inc., Hsin-Chu (TW)

(72) Inventors: Hsing-Chang CHOU, New Taipei City (TW); Shih-Chieh HUANG, New Taipei City (TW); Jen-Chieh LO, Zhushan Township (TW)

(21) Appl. No.: 15/287,978

(22) Filed: Oct. 7, 2016

(51) Int. Cl. G06F 1/32; G06T 1/20

(52) U.S. Cl. CPC G06F 1/3265; G06F 1/3218; G06T 1/20

(57) ABSTRACT

A method for adjusting processing capabilities of an electronic apparatus is provided. The method includes the steps of determining a first boost value for one or more processors according to a first slack time of the processors within a current display refresh interval, and adjusting a processing capability of the processors according to the first boost value.

### BACKGROUND OF THE APPLICATION

### Field of the Application

The application generally relates to processor scaling, and more particularly, to processor scaling based on slack time of one or more processors.

### Description of the Related Art

Power management is always an important issue for electronic systems, especially for those with a limited power budget. For instance, mobile devices are battery-powered and reduction of power consumption allows their batteries to last longer. There are various mechanisms for adjusting processing capabilities that are made available at any given time.

In a conventional design, processing capabilities are adjusted based on the amount of power stored in the battery. The more power is left in the battery, the more processing resources are assigned to be used.

In another conventional design, the processing capabilities are adjusted based on the worst-case workload requirements. While the workload may be relatively low at any point in time (e.g., at night), the possibility exists that the workload may suddenly spike and thus the electronic system is configured to operate assuming that the worst-case workload may actually occur. For example, the processing capabilities are usually pulled up aggressively to ensure that the present workload demand is adequately satisfied. However, power is wasted due to the processing capabilities being configured for a level of performance that is higher than what is necessitated by the present workload demand.

Therefore, it is desirable to have a more flexible and robust way of processor scaling.

### BRIEF SUMMARY OF THE APPLICATION

In an aspect of the application, a method for adjusting processing capabilities of an electronic apparatus is provided. The method comprises the steps of: determining a first boost value for one or more processors according to a first slack time of the processors within a current display refresh interval; and adjusting a processing capability of the processors according to the first boost value.

In another aspect of the application, an electronic apparatus comprising one or more processors and a memory is provided. The memory stores instructions that when executed by the processors cause the electronic apparatus to perform a method for adjusting processing capabilities thereof. The method comprises the steps of: determining a first boost value for one or more processors according to a first slack time of the processors within a current display refresh interval; and adjusting a processing capability of the processors according to the first boost value.

Other aspects and features of the present application will become apparent to those with ordinarily skill in the art upon review of the following descriptions of specific embodiments of the apparatuses and the methods for adjusting processing capabilities thereof, and storage mediums thereof.

### BRIEF DESCRIPTION OF DRAWINGS

The application can be more fully understood by reading the subsequent detailed description and examples with references made to the accompanying drawings, wherein:

FIG. 1 is a block diagram illustrating the hardware architecture of an electronic apparatus according to an embodiment of the application;

FIG. 2 is a block diagram illustrating the software architecture of the electronic apparatus 100 according to an embodiment of the application;

FIG. 3 is a flow chart illustrating the method for adjusting processing capabilities of an electronic apparatus according to an embodiment of the application;

FIG. 4A is an exemplary diagram illustrating the determination of slack time according to an embodiment of the application;

FIG. 4B is an exemplary diagram illustrating the determination of slack time according to another embodiment of the application;

FIG. 5A is an exemplary diagram illustrating the relationship between slack time and the boost value for a touch event;

FIG. 5B is an exemplary diagram illustrating the relationship between slack time and the boost value for a non-touch event; and

FIG. 6 is a schematic diagram illustrating the comparison of the conventional design and the present application regarding the processing capabilities configured to meet the requirement of a touch event.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof.

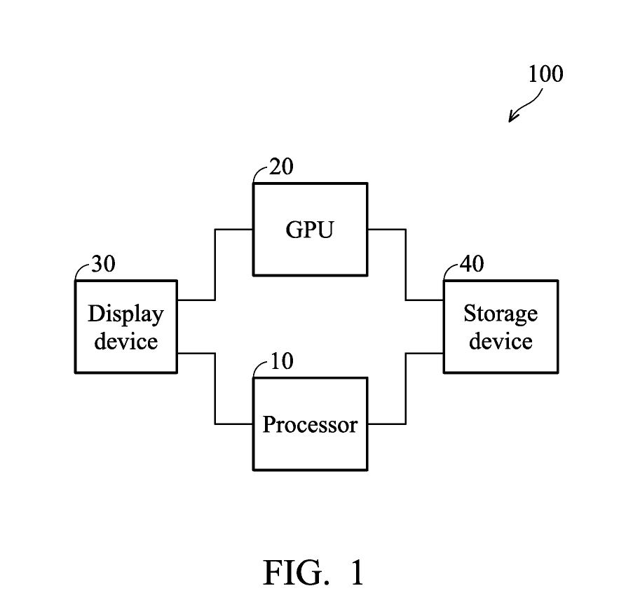

FIG. 1 is a block diagram illustrating the hardware architecture of an electronic apparatus according to an embodiment of the application. The electronic apparatus 100 includes a processor 10, a Graphics Processing Unit (GPU) 20, a display device 30, and a storage device 40. The electronic apparatus 100 may be a mobile phone, a smart phone, a panel Personal Computer (PC), a notebook, a general-purpose computer, or another such apparatus.

The processor 10 may be a general-purpose processor (e.g., a Central Processing Unit (CPU)), a Micro Control Unit (MCU), an application processor, a Digital Signal Processor (DSP), or the like, which includes various circuitry for controlling the GPU 20 to send a series of frame data (e.g. representing text messages, graphics, images, etc.) to the display device 30, and storing and retrieving data to and from the storage device 40. In particular, the processor 10 coordinates the aforementioned operations of the GPU 20, the display device 30, and the storage device 40 for performing the method for adjusting processing capabilities of the electronic apparatus 100.

The GPU 20 also includes various circuitry for providing the function of graphics and image processing and for outputting the frame data to the display device 30.

As will be appreciated by persons skilled in the art, the circuitry of the processor 10 and the GPU 20 will typically include transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The display device 30 may be a Liquid-Crystal Display (LCD), Light-Emitting Diode (LED) display, or Electronic Paper Display (EPD), etc., for providing a display function, including the generation of vertical synchronization pulses. Alternatively, the display device 30 may be a touch-sensitive display which further comprises one or more touch sensors disposed thereon or thereunder for sensing touches, contacts, or proximities of objects, such as fingers or styluses.

The storage device 40 is a non-transitory machine-readable storage medium, such as a memory, (e.g., a FLASH memory or a Non-volatile Random Access Memory (NVRAM)), or a magnetic storage device, (e.g., a hard disk or a magnetic tape), or an optical disc, or any combination thereof for storing processed frame data to be displayed, and storing instructions and/or program code of applications, communication protocols, and/or the method of the present application.

It should be understood that the components described in the embodiment of FIG. 1 are for illustrative purposes only and are not intended to limit the scope of the application. For example, the electronic apparatus 100 may further include a GPS for providing location information, an input device (e.g., buttons, a keyboard, a mouse, a touch pad, a video camera, a microphone, and/or a speaker, etc.) for serving as the Man-Machine Interface (MMI) for interaction with users, and/or a communication device for providing the function of wired and/or wireless data communications.

To further clarity, if the electronic apparatus 100 supports the function of wired data communication, the communication device may include a cable modem, an Asymmetric Digital Subscriber Line (ADSL) modem, a Fiber-Optic Modem (FOM), an Ethernet network interface, or another wired interface. If the electronic apparatus 100 supports the function of wireless data communication, it may include an antenna, an RF device, and a baseband processing device. A baseband processing device may be configured to perform baseband signal processing and control the communications between one or more subscriber identity cards and the RF device. The baseband processing device may contain multiple hardware components to perform the baseband signal processing, including Analog-to-Digital Conversion (ADC)/Digital-to-Analog Conversion (DAC), gain adjusting, modulation/demodulation, encoding/decoding, and so on. An RF device may receive RF wireless signals via the antenna, convert the received RF wireless signals to baseband signals, which are processed by the baseband processing device, or receive baseband signals from the baseband processing device and convert the received baseband signals to RF wireless signals, which are later transmitted via the antenna. The RF device may also contain multiple hardware devices to perform radio frequency conversion. For example, the RF device may comprise a mixer to multiply the baseband signals with a carrier oscillated in the radio frequency of the supported cellular technologies, wherein the radio frequency may be 2.4 GHz, 3.6 GHz, 4.9 GHz, or 5 GHz utilized in the Wireless Fidelity (WiFi) technology, or may be 900 MHz, 1800 MHz or 1900 MHz utilized in General Packet Radio Service (GPRS) or Enhanced Data rates for Global Evolution (EDGE) technology, or may be 900 MHz, 1900 MHz or 2100 MHz utilized in the Wideband Code Division Multiple Access (WCDMA) technology, or may be 900 MHz, 2100 MHz, or 2.6 GHz utilized in the Long Term Evolution (LTE), Time- Division LTE (TD-LTE), or LTE-Advanced (LTE-A) technology, or another radio frequency, depending on the Radio Access Technology (RAT) in use.

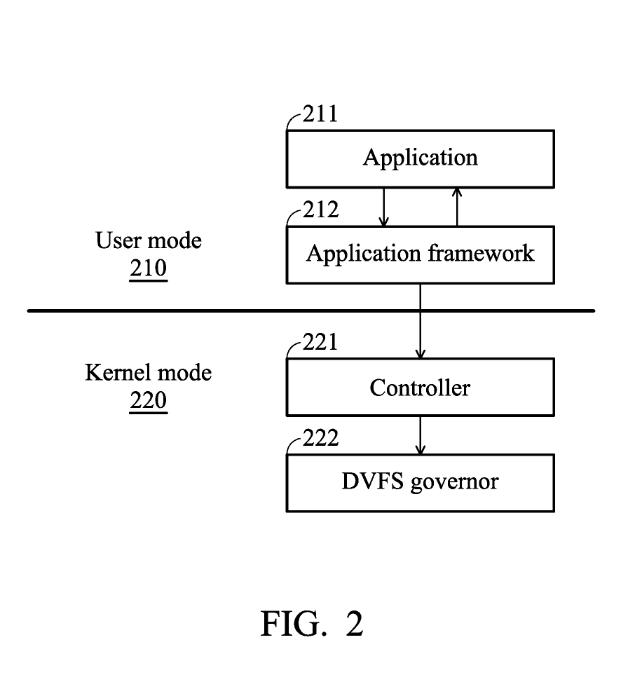

FIG. 2 is a block diagram illustrating the software architecture of the electronic apparatus 100 according to an embodiment of the application. The software architecture includes a user mode 210 and a kernel mode 220, wherein the kernel mode 220 is associated with running a privileged Operating System (OS) kernel, kernel extensions, and most device drivers while the user mode 210 is associated with executing applications. In one embodiment, the OS may be an Android system.

The user mode 210 includes at least an application 211 and an application framework 212, wherein the application framework 212 is a software library that supports the execution of the application 211 for a specific environment, and the application 211 is a software program designed to perform a group of coordinated functions, tasks, or activities for the benefit of the user. Examples of the application 211 may include a word editor, a web browser, a media player, a photo editor, and a console game, etc. During the execution of the application 211, the application framework 212 particularly collects and outputs information concerning the slack time of the processor 10 and the GPU 20 for each display refresh interval.

The kernel mode 220 includes a controller 221 and a Dynamic Voltage and Frequency Scaling (DVFS) governor 222, wherein the controller 211 is responsible for making decisions of how the processing capabilities of the electronic apparatus 100 should be adjusted based on the information provided by the application framework 212, and controlling the DVFS governor 222 to apply the decisions for adjusting the processing capabilities of the processor 10 and/or the GPU 20.

In one embodiment, the controller 211 may implement a technique called Energy Aware Scheduling (EAS) for performing the aforementioned functions related to power management.

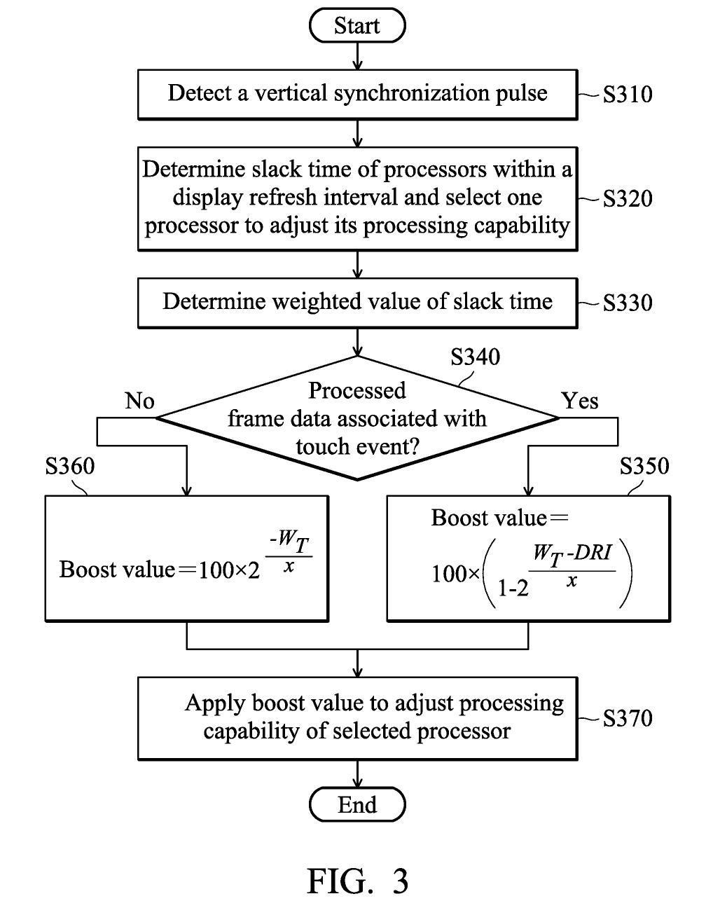

FIG. 3 is a flow chart illustrating the method for adjusting processing capabilities of an electronic apparatus according to an embodiment of the application. In this embodiment, the method is executed by an electronic apparatus, e.g., the electronic apparatus 100. To begin, the generation of a vertical synchronization pulse is detected (step S310). Specifically, the vertical synchronization pulse is generated at the beginning of each display refresh interval.

In response to detecting the vertical synchronization pulse, the electronic apparatus determines the slack time of one or more processors therein within a display refresh interval which is bounded between the current vertical synchronization pulse and the previous vertical synchronization pulse, and selects one of the processors to be the target for adjusting its processing capability (step S320). In another embodiment, the electronic apparatus may choose to select two or more of the processors for adjustment of their processing capabilities, and the application cannot be limited thereto.

Please note that, in another embodiment, a display refresh interval may be instead defined as a period of time bounded between a first time instant where the processors start processing the frame data and a second time instant where the processed frame data is retrieved for screen display. Specifically, the second time instant may be latter than the current vertical synchronization pulse.

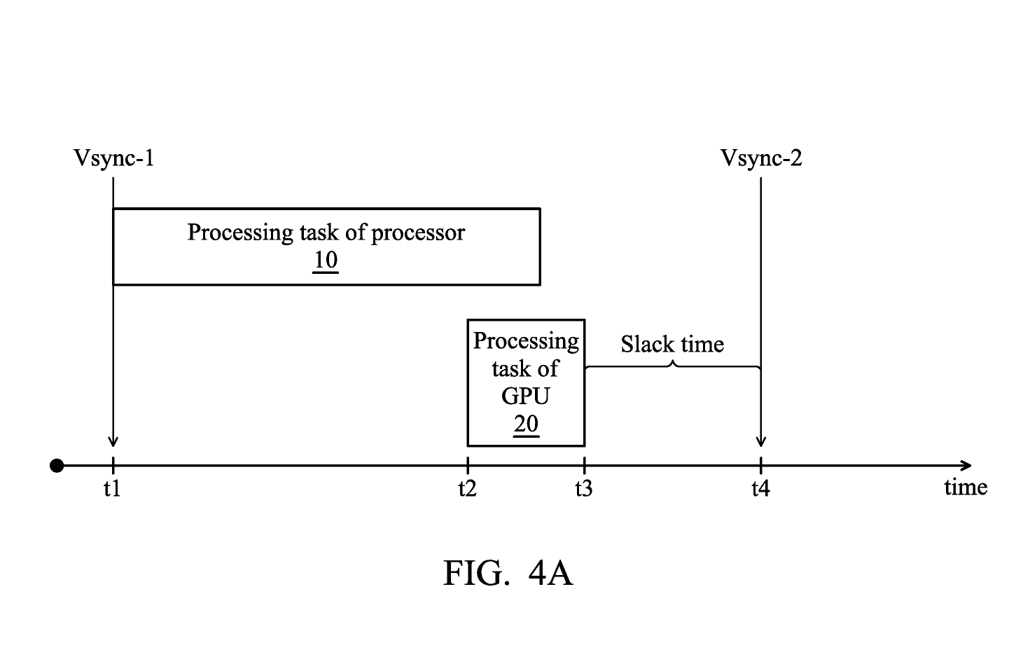

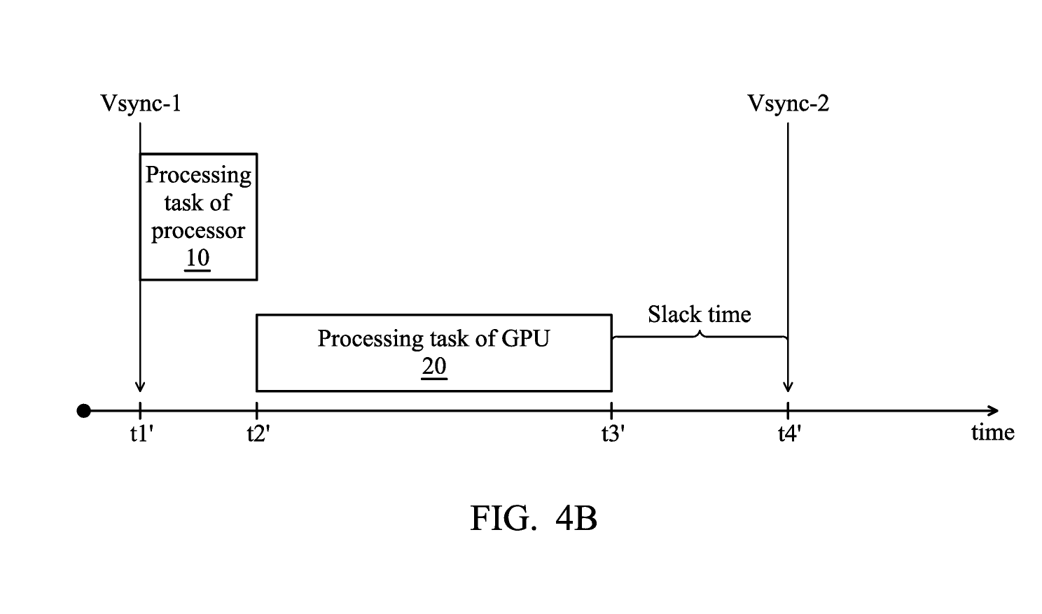

Specifically, the slack time refers to the period of time in the display refresh interval that is left after the processors finish processing the frame data for the next screen display. FIG. 4A is an exemplary diagram illustrating the determination of slack time according to an embodiment of the application. As shown in FIG. 4A, the processor 10 starts processing the frame data at time t1 which the first vertical synchronization pulse (denoted as Vsync-1) is generated. When the processor 10 finishes processing the frame data at time t2, it sends the processed frame data to the GPU 20 for subsequent processing and then continues with other tasks that may be related to User Interface (UI) handling. Next, the GPU 20 starts processing the processed frame data at time t2 and finishes the processing at time t3. The slack time refers to the period of time starting from time t3 to time t4 at which the second vertical synchronization pulse (denoted as Vsync-2) is generated. In this embodiment, the processor 10 requires more time than the GPU 20 does for processing the frame data. Therefore, the processor 10 may be selected as the target for adjusting its processing capability, due to the fact that it is the bottleneck of the frame data processing and there is a good chance that the overall processing time may be greatly reduced by increasing the processing capability of the processor 10.

FIG. 4B is an exemplary diagram illustrating the determination of slack time according to another embodiment of the application. As shown in FIG. 4B, the processor 10 starts processing the frame data at time t1′ which the first vertical synchronization pulse is generated. When the processor 10 finishes processing the frame data at time t2′, it sends the processed frame data to the GPU 20 for subsequent processing. Next, the GPU 20 starts processing the processed frame data at time t2′ and finishes the processing at time t3′. The slack time refers to the period of time starting from time t3′ to time t4′ at which the second vertical synchronization pulse is generated. In this embodiment, the GPU 20 requires more time than the processor 10 does for processing the frame data. Therefore, the GPU 20 may be selected as the target for adjusting its processing capability, due to the fact that it is the bottleneck of the frame data processing and there is a good chance that the overall processing time may be greatly reduced by increasing the processing capability of the GPU 20.

Referring back to FIG. 3, subsequent to step S320, the electronic apparatus determines a weighted value (denoted as W_{T}) of the slack time (step S330). In one embodiment, the weighted value may be calculated according to the following equation:

$${W}_{T} = \{ \begin{matrix}Average slack time , if T \leq 5 \\ α \times {SlackTime}_{T} + ( 1 - α ) \times {W}_{T - 1} , if T > 5\end{matrix} \} \qquad ( 1 )$$

W_{T} represents the weighted value of the slack time which is determined at the (T+1)-th vertical synchronization pulse, and W_{T-1} represents the weighted value of the slack time which is determined at the T-th vertical synchronization pulse, wherein T is an integer. The average slack time refers to the average of the first T slack times when T is less than or equal to 5. The variable a is a number between 0 and 1.

Next, it is determined whether the processed frame data is associated with a touch event (step S340), and if so, the electronic apparatus determines a boost value for the selected processor according to the weighted value of the slack time, in a way that the performance of the selected processor may be improved aggressively (step S350). In one embodiment, the boost value is a number between 0 and 100, wherein a greater number indicates the need to pull up the processing capability to a higher level. The boost value may be calculated according to the following equation:

$$Boost value = 100 \times ( 1 - {2}^{\frac{{W}_{T} - DRI}{x}} ) \qquad ( 2 )$$

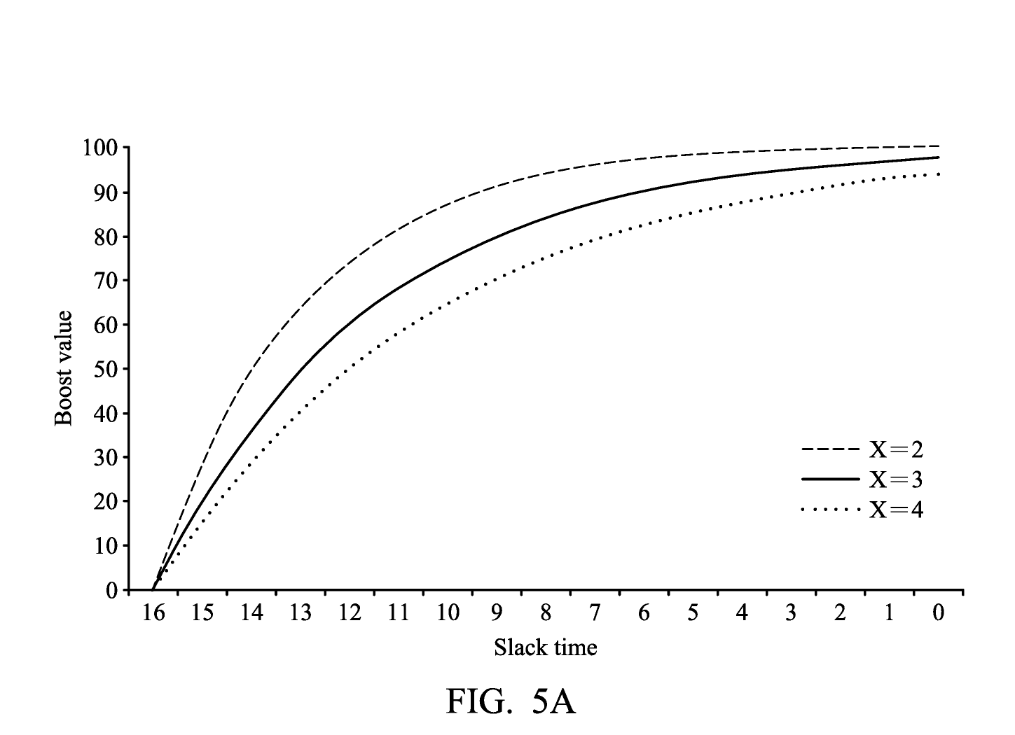

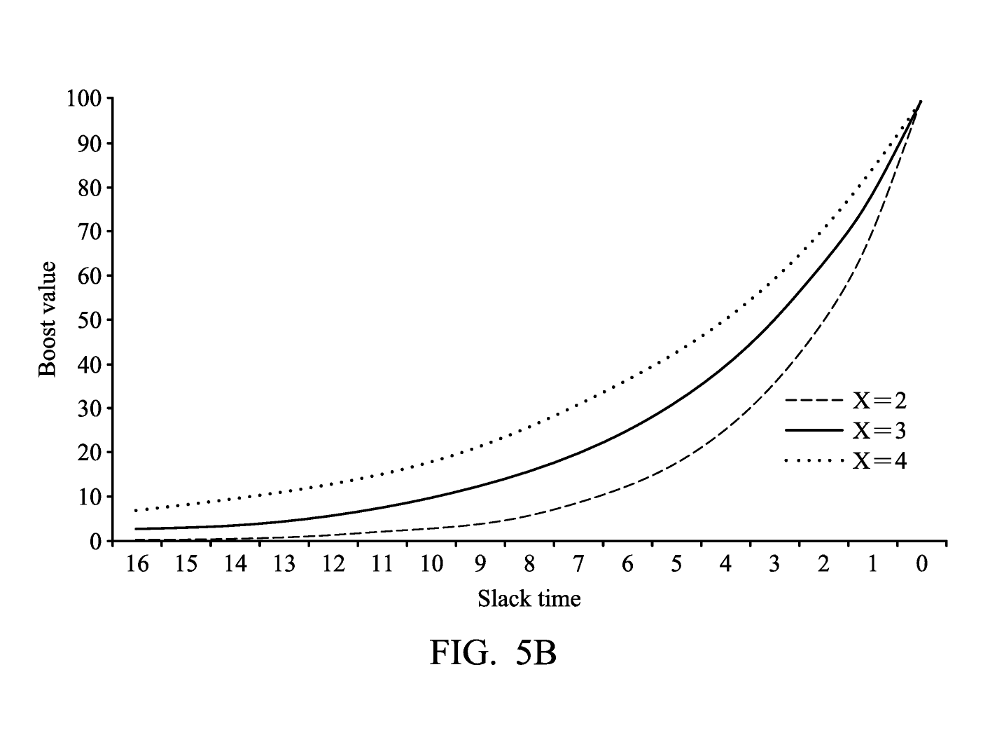

The variable x is an integer. The variable DRI is the display refresh interval, such as 16.6 milliseconds in the Android system. FIG. 5A is an exemplary diagram illustrating the relationship between slack time and the boost value for a touch event.

Subsequent to step S340, if the frame data is not associated with a touch event, the electronic apparatus determines a boost value for the selected processor according to the weighted value of the slack time, in a way that the performance of the selected processor may be improved slowly (step S360). The boost value may be calculated according to the following equation:

$$Boost value = 100 \times {2}^{\frac{- {W}_{T}}{x}} \qquad ( 3 )$$

FIG. 5B is an exemplary diagram illustrating the relationship between slack time and the boost value for a non-touch event.

After that, the electronic apparatus applies the boost value to adjust the processing capability of the selected processor (step S370), and the method ends.

In another embodiment, the method may be stopped for a period of time if the slack time determined at the next vertical synchronization pulse is not decreased, and then resumed when the period of time has elapsed.

The processing capability may include the clock frequency of the selected processor, or the number of activated cores of the selected processor, or the type of the activated core of the selected processor.

In one embodiment, if the boost value is greater than a predetermined threshold, the selected processor is adjusted to operate in a higher clock frequency, and otherwise, the selected processor is adjusted to operate in a lower clock frequency.

In one embodiment, the selected processor includes multiple processing cores, and the greater the boost value is, the more number of the processing cores are activated.

In one embodiment, the selected processor includes a big core, a little core, and a micro core, wherein the big core is a central processing unit with the greatest computing power among all the processing cores, the little core is a central processing unit with a lower computing power than the big core, and the micro core is a central processing unit with the least computer power among all the processing cores. When the boost value is lower than or equal to a first threshold, only the micro core is activated and configured to operate in 500 MHz. When the boost value is greater than the first threshold and lower than or equal to a second threshold, only the micro core is activated and configured to operate in 1 GHz. When the boost value is greater than the second threshold and lower than or equal to a third threshold, only the little core is activated and configured to operate in 1.4 GHz. When the boost value is greater than the third threshold and lower than or equal to 100, only the big core is activated and configured to operate in 1 GHz. Please note that the first threshold is less than the second threshold, and the second threshold is less than the third threshold.

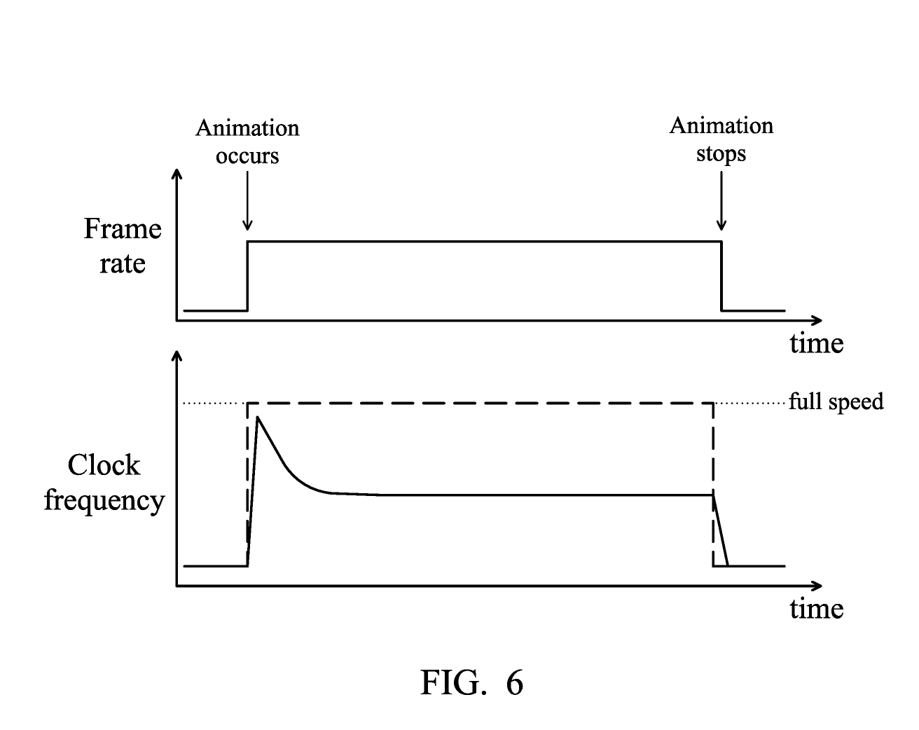

In view of the forgoing embodiments, it will be appreciated that the present application realizes a more robust and energy efficient way of processor scaling by dynamically adjusting the processing capabilities of the processor(s) based on the slack time of the processors. FIG. 6 is a schematic diagram illustrating the comparison of the conventional design and the present application regarding the processing capabilities configured to meet the requirement of a touch event. In the conventional design (denoted by the dotted line), when the touch event occurs which causes an animation to be continuously displayed, the clock frequency of the processor 10 or GPU 20 is pulled up straight to the full speed and maintains in the full speed until the animation comes to an end. By contrast, in the present application (denoted with the solid line), the clock frequency of the processor 10 or GPU 20 is pulled up aggressively near but under the full speed and then gradually reduced to a lower speed that is just enough to support the animation in smooth display. Advantageously, the present application greatly reduces the power consumption of the electronic apparatus without sacrificing performance and user experience.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first” and “second” in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A method for adjusting processing capabilities of an electronic apparatus, the method comprising:
determining a first boost value for one or more processors according to a first slack time of the processors within a current display refresh interval; and
adjusting a processing capability of the processors according to the first boost value.

2. The method of claim 1, wherein the current display refresh interval is bounded between a current vertical synchronization pulse and a previous vertical synchronization pulse.

3. The method of claim 1, wherein the current display refresh interval is bounded between a first time instant where the processors start processing frame data and a second time instant where the processed frame data is retrieved for screen display.

4. The method of claim 1, further comprising:
determining a second boost value for the processors according to a second slack time of the processors within a previous display refresh interval;
wherein the first boost value is determined further according to the second boost value.

5. The method of claim 1, further comprising:
generating a determination result of whether the processors are configured to process frame data associated with a touch event;
wherein the processing capability of the processors is adjusted further according to the determination result.

6. The method of claim 1, wherein the processing capability comprises at least one of the following:
a respective clock frequency of each of the processors;
a respective number of activated cores of each of the processors; and
a respective type of an activated core of each of the processors.

7. An electronic apparatus, comprising:
one or more processors; and
a memory, storing instructions that when executed by the processors cause the electronic apparatus to perform a method for adjusting processing capabilities thereof, the method comprising:
determining a first boost value for the processors according to a first slack time of the processors within a current display refresh interval; and
adjusting a processing capability of the processors according to the first boost value.

8. The electronic apparatus of claim 7, wherein the current display refresh interval is bounded between a current vertical synchronization pulse and a previous vertical synchronization pulse.

9. The electronic apparatus of claim 7, wherein the current display refresh interval is bounded between a first time instant where the processors start processing frame data and a second time instant where the processed frame data is retrieved for screen display.

10. The electronic apparatus of claim 7, wherein the method further comprises:
determining a second boost value for the processors according to a second slack time of the processors within a previous display refresh interval;
wherein the first boost value is determined further according to the second boost value.

11. The electronic apparatus of claim 7, wherein the method further comprises:
generating a determination result of whether the processors are configured to process frame data associated with a touch event;
wherein the processing capability of the processors is adjusted further according to the determination result.

12. The electronic apparatus of claim 7, wherein the processing capability comprises at least one of the following:
a respective clock frequency of each of the processors;
a respective number of activated cores of each of the processors; and
a respective type of an activated core of each of the processors.
